(19) United States
(12) Patent Application Publication
(10) Pub. No.: US 2010/0114535 A1
(43) Pub. Date: May 6, 2010

(54) Grow Planning

(75) Inventor: Jeremy Gibson Dore, Liverpool (GB)

Correspondence Address: Growveg.com Limited, 20 Fountains Way, Liverpool, L37 4HF, GB

(73) Assignee: GrowVeg.com Ltd., Liverpool (GB)

(21) Appl. No.: 12/261,243

(22) Filed: Oct. 30, 2008

(51) Int. Cl. G06F 17/50

(52) U.S. Cl. 703/1

(57) ABSTRACT

A computer implemented method of displaying a plan of an area for growing plants. The method comprises displaying a graphical representation of said area, receiving from a user selection of a plant to be included in said plan, and displaying a graphical representation of said user selected plant wherein said graphical representation of said user selected plant indicates a growing area required for optimal growth of said plant.

The present invention relates to methods and apparatus suitable for use in grow planning. More particularly, but not exclusively, the invention relates to methods for determining an advantageous plan for planting vegetables, herbs and/or fruit.

Many people grow their own fruit and vegetables either at home in a reserved space within their garden or in any other suitable growing area such as a community garden. A growing area is often divided into a number of separate growing areas called beds, separated by paths. Separating a growing area into beds in this way provides convenient access to different parts of the growing area. Individual beds are often planted with a single plant type, or a number of plant types that are suited to growing alongside each other.

Some gardeners rotate crops from one year to another. Rotation of crops involves planting a first crop in a particular area during a first time period, and a second different crop in that area during a second time period, the first and second crops being specifically chosen because of their inherent characteristics. Crop rotation can improve soil fertility and structure and help manage diseases and insects that affect a specific plant family. Plants in the same botanical family have similar nutrient requirements and planting similar plants in the same area without any rotation can deplete the soil of particular nutrients. Insects and other disease carrying organisms can survive in soil between growing seasons and planting similar plants for consecutive years that are affected by the same diseases can increase the risk of damage to yields. Additionally, some plants can be beneficial to soil such as peas and beans which enrich soil through the action of nitrogen fixation.

Dividing a growing area into beds simplifies crop rotation as each bed can be planted with a particular type of plant one year and a different type of plant the next year. Following such a planting scheme provides an easy to follow method allowing the benefits of crop rotation to be realized. In order to keep the rotation method simple to follow, plants are normally categorized into a small number of groups. Known rotations include a three-year cycle and a four-year cycle in which plants are grouped into three or four broad categories and rotated between multiples of three or four beds. Common vegetables can be categorized into seven or more groups and each group is affected by different growing conditions and disease. Broadly categorizing vegetables into the three or four broad categories as in the known systems discussed above is therefore undesirable.

A further requirement for optimal growth of plants relates to the spacing between individual plants. Some plants such as potatoes require a large amount of space between individual plants whereas other plants such as carrots require only a small amount of space between plants. Additionally, within a row particular plants will usually require slightly less space between plants than a single plant will require between it and a plant of another type. Spacing can sometimes be determined by the expected size of a fully-grown plant, however this is not always the case. For example potatoes require a large amount of space due to the size of the plant underneath the soil. It is therefore difficult to determine an optimal spacing between plants.

It is an object of embodiments of the present invention to obviate or mitigate at least one of the problems mentioned above.

According to a first aspect of the present invention, there is provided a computer implemented method of displaying a plan of an area for growing plants. The method comprises displaying a graphical representation of said area, receiving from a user selection of a plant to be included in said plan and displaying a graphical representation of said user selected plant, wherein said graphical representation of said user selected plant indicates a growing area required for optimal growth of said plant.

Displaying a graphical representation of a growing area required for optimal growth of said plant aids the planning of a garden by providing a visual indication of where plants should be planted in relation to the other plants.

The indicated growing area may be determined based upon space required by the selected plant above and/or below soil in which the plant is to be planted.

The method may further comprise receiving from a user a selection of an area of said plan to be populated with said selected plant.

The method may further comprise calculating a quantity of said selected plant based upon said growing area and said user selection of an area to be populated with the selected plant. Data indicating said calculated quantity may be displayed. A single plant may be represented by an icon, and said quantity may be indicated by the number of displayed icons.

The graphical representation of said user selected plant may further comprise an indication of a classification of said selected plant. The classification may be a classification based upon a plant family of the user selected plant. The plant family may be selected from the group consisting of Solanaceae, Brassicaceae, Alliaceae, Chenopodiaceae, Umbelliferae, Leguminosae, Cucurbitaceae and Miscellaneous.

The method may further comprise, for each of a plurality of plants, storing first data indicating a growing area required for optimal growth of said plant when planted individually and storing second data indicating a growing area required for optimal growth of said plant when planted in rows.

According to a second aspect of the present invention there is provided a computer implemented method of displaying a plan of an area for growing plants. The method comprises displaying a graphical representation of said area, receiving from a user selection of a plant to be included in said plan and displaying a graphical representation of said user selected plant, wherein said graphical representation of said user selected plant indicates a plant family to which the selected plant belongs.

Many growers prefer to plant plants that are in the same family in the same bed or to keep plants from particular families separated. Providing a visual display of a plant family of a particular plant makes it easier to identify plant groupings and to plan a garden according to plant family in this way.

The plant family may be selected from the group consisting of Solanaceae, Brassicaceae, Alliaceae, Chenopodiaceae, Umbelliferae, Leguminosae, Cucurbitaceae and Miscellaneous.

The graphical representation of said user selection may comprise a color, and said color may indicate a plant family to which the selected plant belongs.

According to a third aspect of the present invention there is provided a computer implemented method of displaying a plan of an area for growing plants. The method comprises displaying a graphical representation of said area, receiving from a user selection of a plant to be included in said plan and indicating parts of said area that are suitable for planting said selected plant based upon said plant selection and historical data.

Planting of plants that belong to the same family in a particular area is not recommended in consecutive years due to the similar nutrient requirements of plants that belong to the same family. Crop rotation can further improve soil fertility and structure and help manage diseases and insects that affect a specific plant family. Providing an indication of where a particular plant should be planted can help gardeners manage their crop rotations.

The historical data may be historical planting data for said area for growing plants. The historical planting data may be automatically generated from at least one previous plan for said area for growing plants. The historical data may be stored in a database.

Indicating parts of said area that are suitable for planting said selected plant may comprise displaying graphical data indicating areas which are not suitable for planting said selected plant.

Indicating parts of said area that are suitable for planting said selected plant may comprise displaying graphical data indicating areas which are suitable for planting said selected plant.

The graphical data may indicate a degree of suitability of a particular area for planting said selected plant.

According to a fourth aspect of the present invention there is provided a computer implemented method of planning an area for growing plants. The method comprises receiving data indicating a plan for an area for growing plants including data indicating plant selections and automatically generating a plan indicating when said selected plants should be planted based upon said plan and stored data indicating characteristics of the selected plants.

In this way a user is provided with a clear plan relating to tasks which should be carried out at a particular time.

The plan may be generated further based upon data indicating at least one climatic condition. The at least one climatic condition may be based upon a frost date.

The method may further comprise generating at least one reminder message based upon said plan indicating when said selected plants should be planted and providing said at least one reminder message to a user. The reminder message may be, for example, an email reminder.

It will be appreciated that aspects of the invention can be implemented in any convenient form. For example, the invention may be implemented by appropriate computer programs which may be carried on appropriate carrier media which may be tangible carrier media (e.g. disks) or intangible carrier media (e.g. communications signals). Aspects of the invention may also be implemented using suitable apparatus which may take the form of programmable computers running computer programs arranged to implement the invention. The programmable computers may be server computers and the invention may be accessed on a client computer via a communications network such as the Internet.

Embodiments of various aspects of the present invention will now be described, by way of example only, with reference to the accompanying drawings, in which:

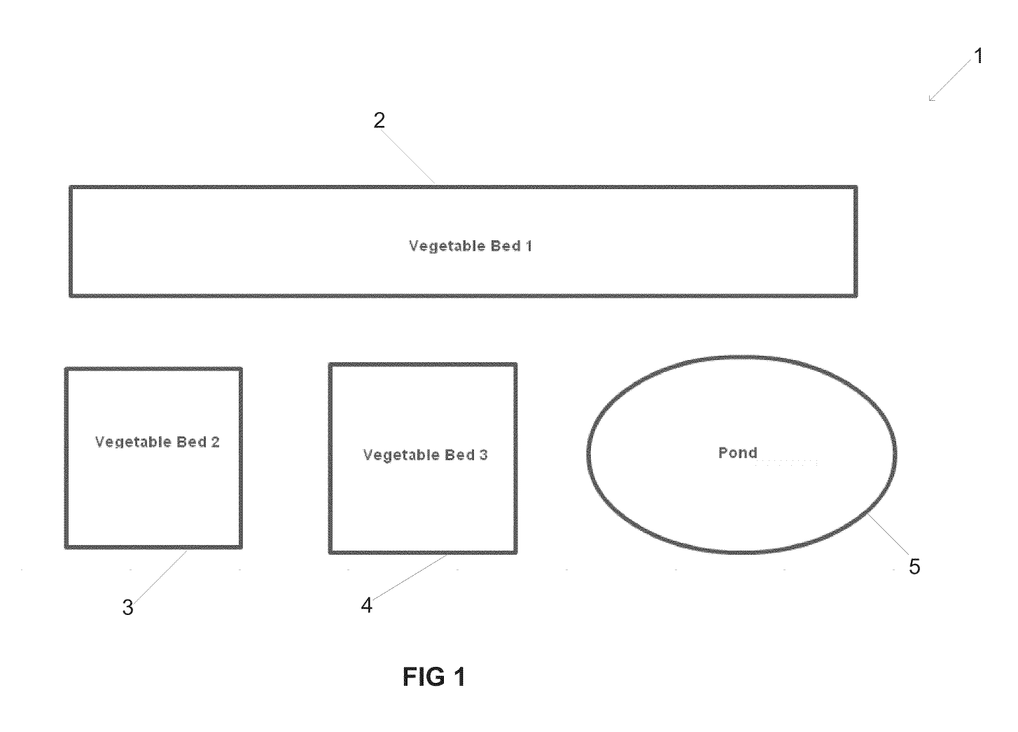

FIG. 1 is a schematic illustration in plan view of a growing area;

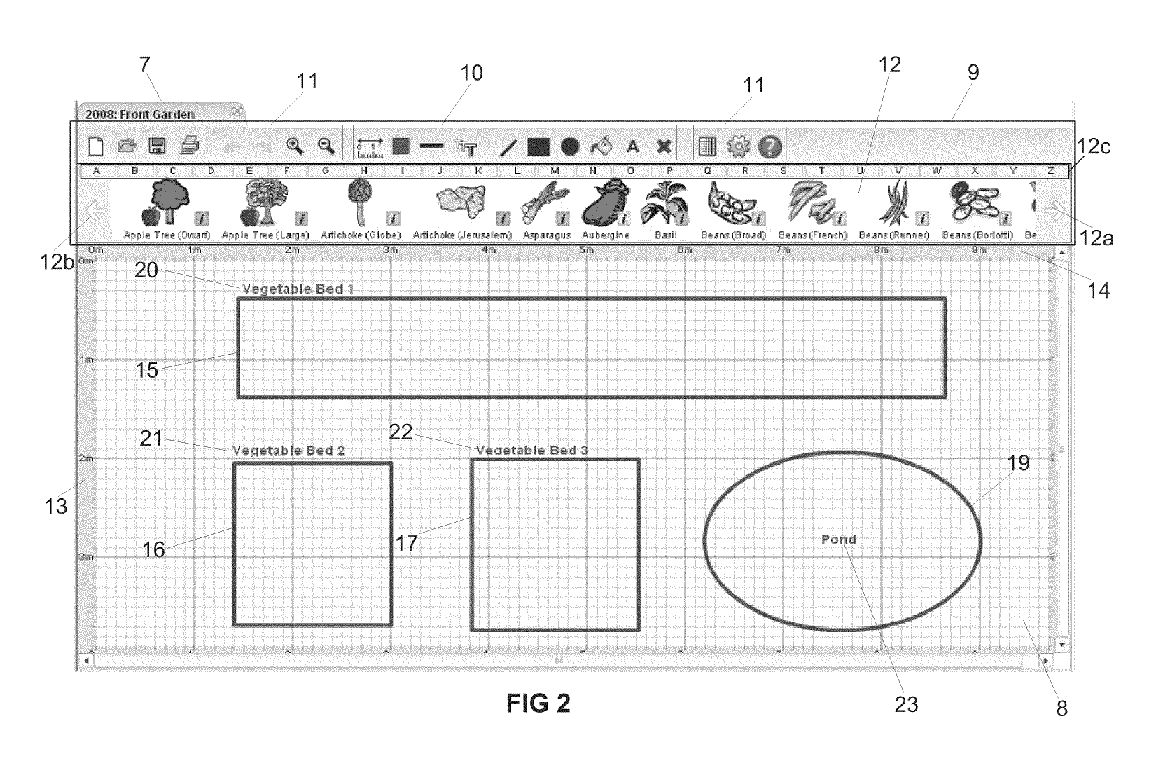

FIG. 2 is a screen shot of a grow area planner application interface including a scale plan of the growing area of FIG. 1;

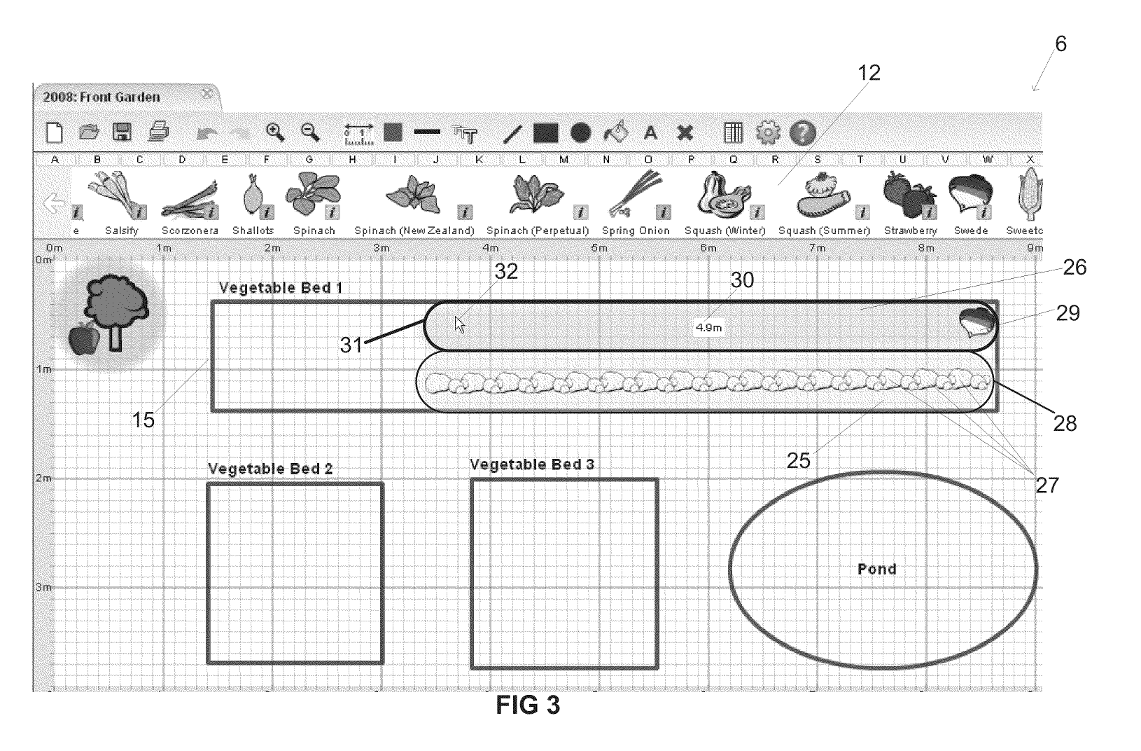

FIG. 3 is a screen shot showing the interface of FIG. 2 being used to lay out a growing bed;

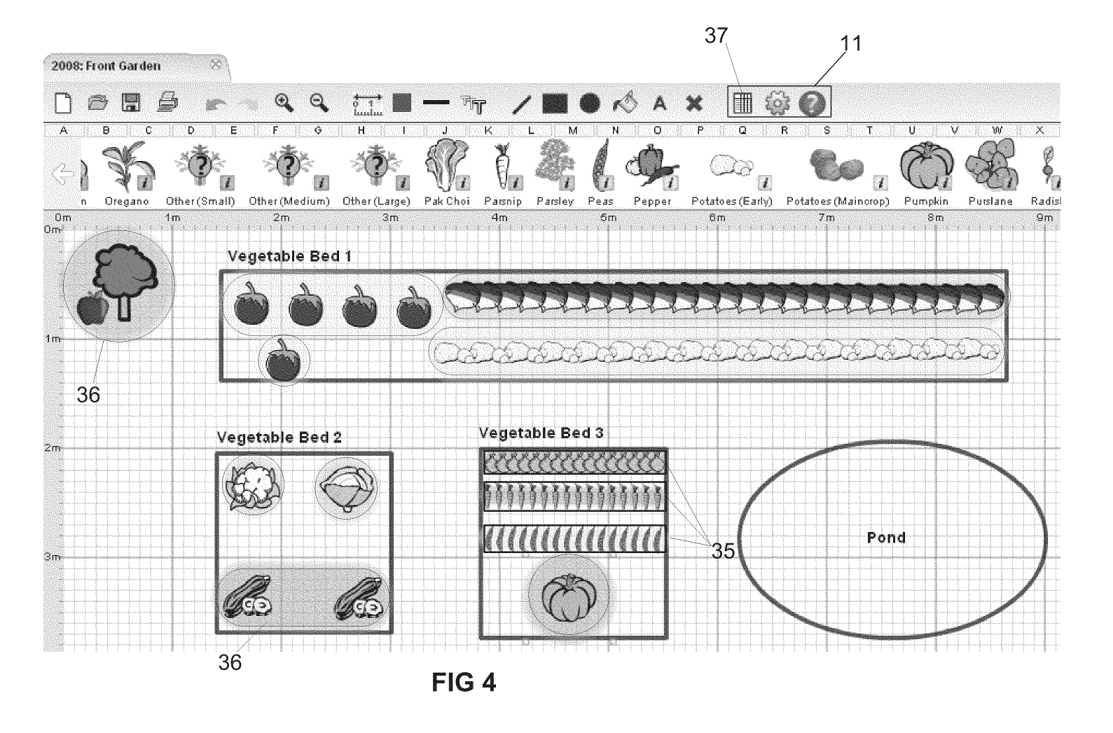

FIG. 4 is a screen shot showing the plan of FIGS. 2 and 3 with additional plants;

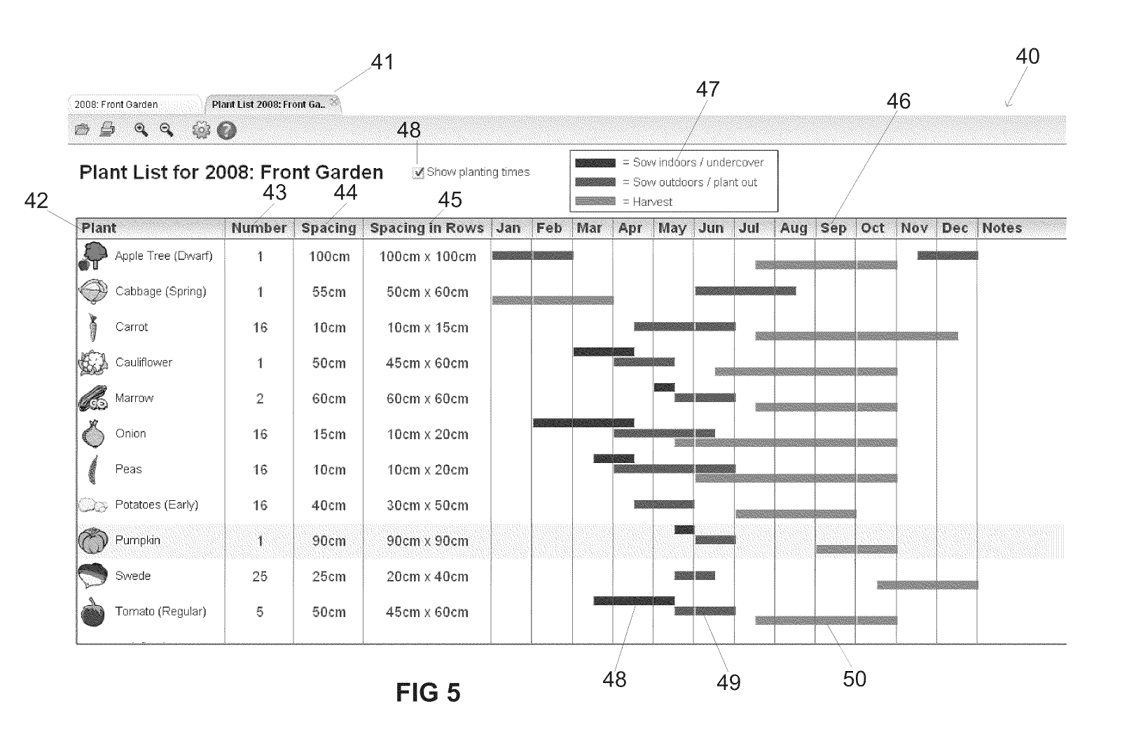

FIG. 5 is a screen shot of a planting planner for the plan of FIG. 4;

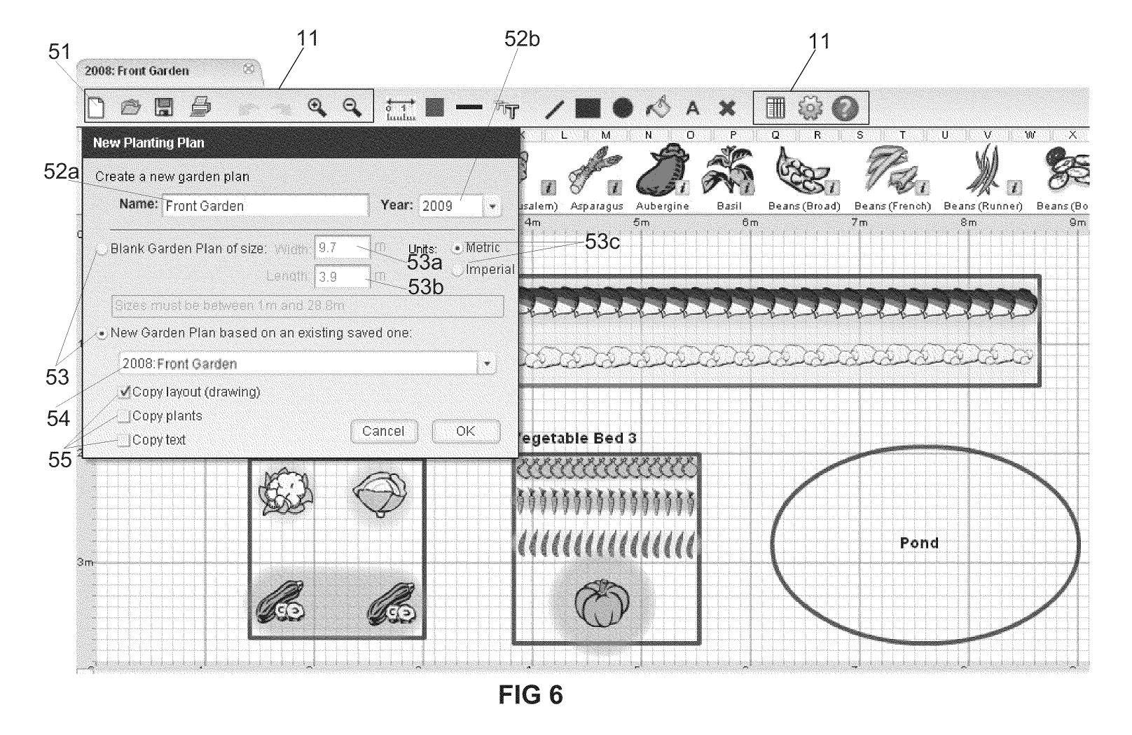

FIG. 6 is a screen shot showing a screen for creating a new plan based upon the plan of FIG. 4;

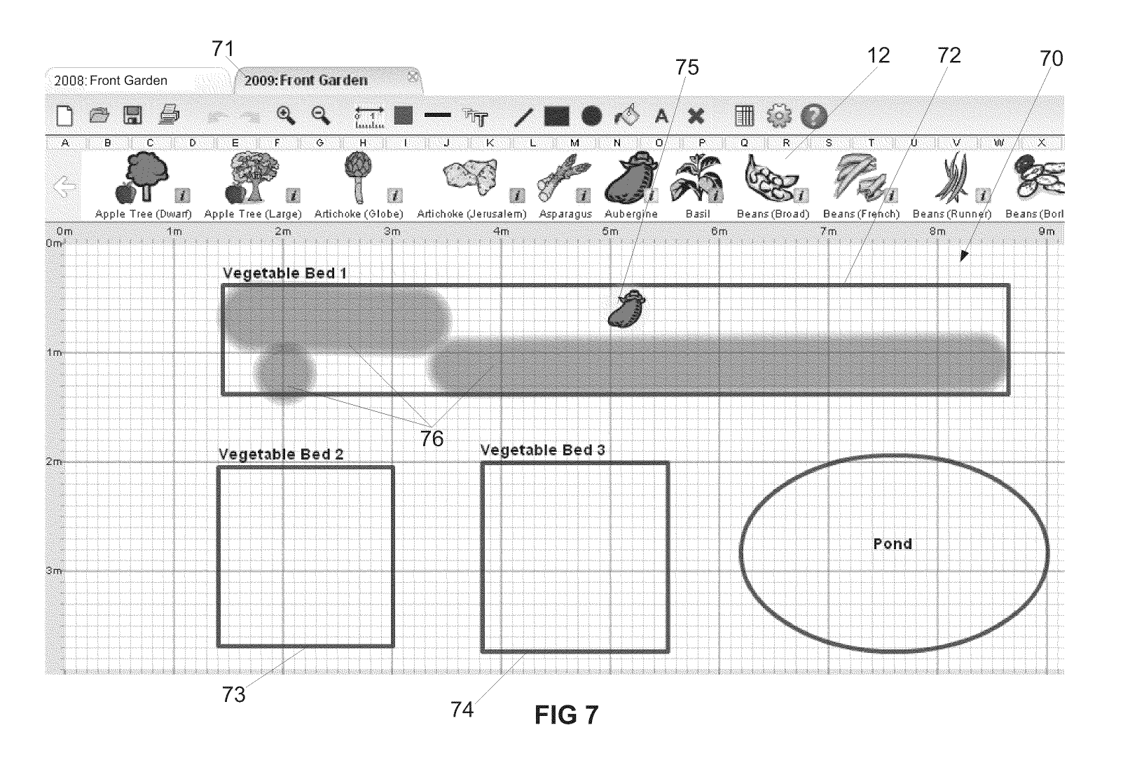

FIG. 7 is a screen shot showing areas of the plan created in FIG. 6 in which a particular plant should not be planted;

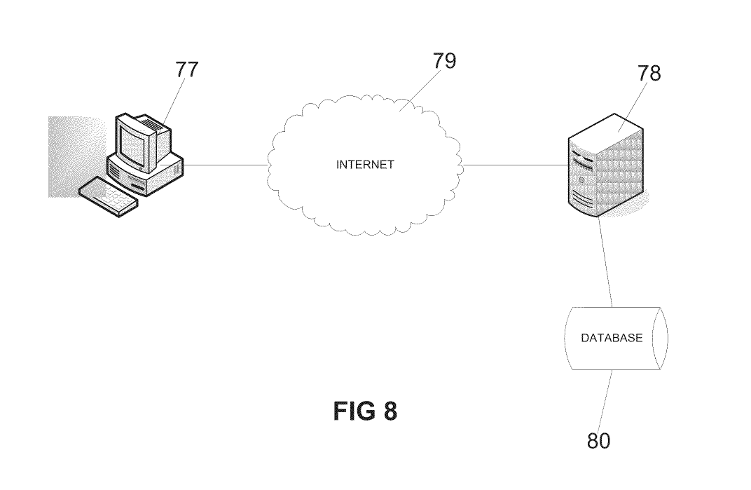

FIG. 8 is a schematic illustration of a computer network which can be used to implement embodiments of the invention;

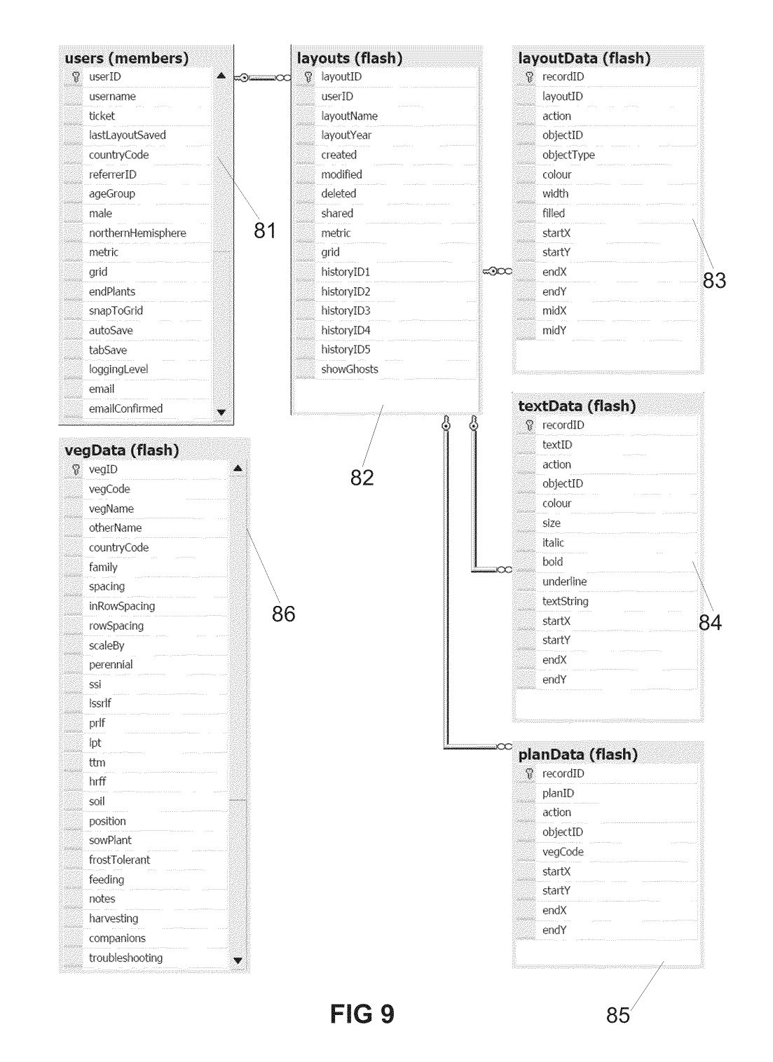

FIG. 9 is a schematic illustration of database tables used by the grow area planner application of FIGS. 2 to 7; and

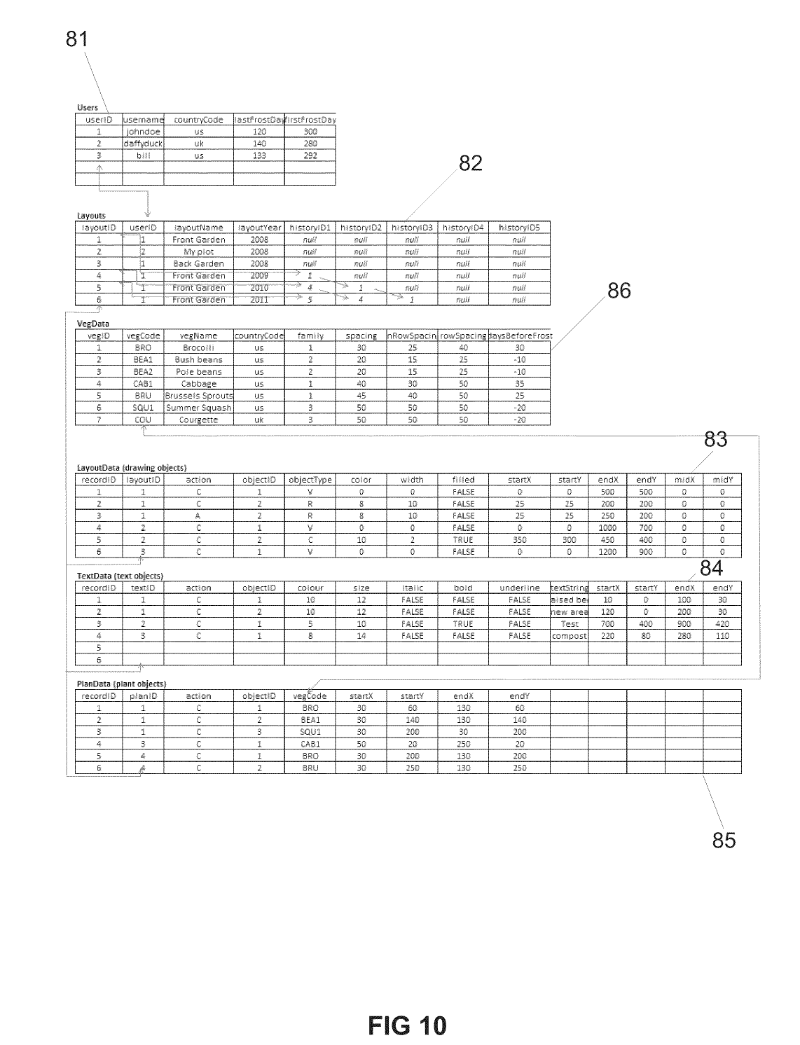

FIG. 10 is a simplified example database according to the database of FIG. 9.

Referring to FIG. 1, a growing area 1 containing vegetable beds 2, 3, 4 and a pond area 5 is shown. The growing area 1 may be any growing area such as an area of garden used for growing fruit and vegetables or a community garden. Before a user plants their growing area for a growing season or year, the user plans the arrangement of their growing area. A well-planned growing area offers a number of benefits including easier management of the growing area and increased fruit and vegetable yield through providing optimal conditions for plants.

Referring to FIG. 2, a screen shot of a grow area planner application is shown. The grow area planner application provides a tab 7, a planning area 8 and a tool bar area 9. The tab 7 provides a label for the plan such as “front garden” or “back yard” as well as the year for which the plan is being created. Multiple tabs may be shown, each containing a different plan and the tabs can be used to move easily between different plans. Different plans, each having an associated tab, may relate to different years or different growing areas.

The tool bar area 9 contains layout tools 10, system tools 11 and plant selection icons 12. The plant selection icons 12 are arranged alphabetically and different plant selection icons can be displayed by selecting a right arrow icon 12a to scroll the plant selection icons 12 from left to right, and by selecting a left arrow icon 12b to scroll the plant selection icons 12 from right to left. Each plant selection icon 12 has an associated name, and selecting one of the alphabet icons 12c results in plant selection icons having associated names beginning with the selected letter being displayed.

The layout tools 10 can be used to create a plan of the growing area 1 as shown in FIG. 1.

A user would ordinarily measure their growing area 1 using appropriate measuring equipment. The measurement data is then input to the grow area planner application to determine the dimensions of the planning area 8. It can be seen that the dimensions of the planning area 8 are displayed by a vertical scale bar 13 and a horizontal scale bar 14.

The planning area 8 contains scale representations 15, 16, 17 of vegetable beds corresponding to vegetable beds 2, 3, 4 of FIG. 1 and a representation 19 corresponding to the pond 5 of FIG. 1. Text 20, 21, 22, 23 is added to the planning area to label individual areas. Shading and coloring may also be added using the layout tools 10, for example the pond may be colored blue to indicate that it is not an area suitable for planting.

Whilst it has been described above that a user inputs measurements of their growing area into the grow area planner application, it will be appreciated that a user may first plan the configuration of a growing area using the grow area planner application and then configure the growing area according to a plan determined using the grow area planner application.

Referring now to FIG. 3, a screen shot showing the laying out of a vegetable bed 15 of the garden plan of FIG. 2 is shown. A user has added a row of potatoes 25 to the vegetable bed 15 and is about to lay out a row of rutabaga (swede) 26 in the same vegetable bed 15. The row of potatoes is illustrated by sixteen potato icons 27 in a growing area 28.

The row of rutabaga 26 is in the process of being added by a user and has not been confirmed. A user draws a row of plants on the plan by selecting the plant to be placed with a cursor controlled by a mouse from the plant selection icons 12. The user selects the starting point of the row of the selected plant with the cursor by pressing the mouse button. The user continues to hold the mouse button whilst moving the cursor to the end of the desired length of row.

The start point of the row of rutabaga 26 that is being placed by the user is illustrated by a single rutabaga 29. A length of row indicator 30 shows that the current length of row that has been selected by the user is 4.9 meters, and a growing area 31 indicates the area required for the row of plants. A cursor 32 is also shown. The cursor 32 indicates the end of the row of rutabaga 26 as currently drawn and release of the mouse button results in a row of rutabaga of length 4.9 meters being placed in the location on the plan as shown. Movement of the cursor 32 to increase or decrease the length of the row of rutabaga before release of the mouse button results in the length of row indicator 30 automatically increasing or decreasing respectively.

Each plant in the plant selection toolbar 12 has an optimal spacing distance associated with it. The growing area indicates the optimal space required for growing the plant with which it is associated. The optimal spacing is determined according to both the size of the plant when fully grown and also other factors such as the amount of space required beneath the soil, which is greater for a plant such as a potato than for a plant such as a rutabaga. The growing area aids the planning of a garden by providing a visual indication of where plants should be planted in relation to the already planted plants. For example in FIG. 3, when planning the row of rutabaga 26, overlap of growing area 28 of the row of potatoes 25 and growing area 31 of the row of rutabaga 26 should be avoided.

The spacing for a particular plant may vary depending on given planting conditions, for example plants in a row may be spaced more closely along the row than individual plants since there will typically be wider gaps between rows to allow for easy access by the gardener.

When a row of a particular plant is added to the plan (for example the row of potatoes 25), data indicating the optimal spacing distance for that plant is used to determine how many plants should be planted in the row. For example, in the case of the row of potatoes 25 it can be seen that sixteen potato plants should be included in the row of potatoes 25 given the length of the row and the growing area required by potato plants. This is represented by the inclusion of sixteen potato icons 27 in the row of potatoes 25.

The growing area associated with each plant, for example the growing area 28 of the row of potatoes 25 and the growing area 31 of the row of rutabaga 26, has a particular color which is determined based upon the plant family to which the plant belongs. For example the row of potatoes 25 of FIG. 3 may have a yellow growing area 28 indicating that potatoes belong to the Solanaceae family, whereas the row of rutabaga 26 may have a green growing area 31 indicating that rutabaga belong to the Brassica family. Other members of the Solanaceae family such as tomatoes will have the same color growing area as the potato, that is, yellow in the example given above. Similarly other members of the Brassica family will have the same color growing area as the rutabaga, in the example given above, green.

As is known by horticulturists, plants can usefully be classified into seven or more groups for the purpose of vegetable growing: Solanaceae, Brassicaceae, Alliaceae, Chenopodiaceae, Umbelliferae, Leguminosae, Cucurbitaceae and Miscellaneous. Each of the respective groups is assigned a different color and all members of the group have a growing area of the same color. Many growers prefer to plant plants that are in the same family in the same bed or to keep particular plants from particular families separated. Providing a visual display of a plant family of a particular plant makes it easier to identify plant groupings and to plan a garden according to plant family in this way.

Referring now to FIG. 4, the plan of FIG. 3 for the year 2008 is shown with a number of vegetables added. Varying sizes of growing areas can be seen ranging from small growing areas 35 associated with onions, carrots and peas to large growing areas 36 associated with summer squash and an apple tree.

A user is able to use the garden plan as set out in FIG. 4 to plant their garden using the scale indicated in the plan. Selection of a plant list icon 37 in system tools area 11 generates a plant list as shown in FIG. 5, and discussed below.

Referring now to FIG. 5, a plant list 40 for the garden plan of FIG. 4 is shown. The plant list opens in a new tab 41 and a user is able to quickly and easily move between the plant list 40 and the garden plan of FIG. 4 by selection of the corresponding tab. The plant list contains a plant column 42 that contains a list of all plants that have been added to the corresponding garden plan. The plant list 40 further contains a number column 43, a spacing column 44 and a spacing in rows column 45. The number column 43 contains a corresponding quantity for each plant in the plant column 42. Each quantity in number column 43 is an indication of how many plants should be planted in the area selected on the garden plan by the user. This information is useful to a user in determining how many plants of a particular type are required to plant their garden.

Spacing column 44 indicates the distance that should be allowed for a plant of a particular type when planted as an individual plant (i.e. not as part of a row). A user can use the information given to measure the space that should be allocated to a particular plant when the garden is planted. The spacing in rows column 45 indicates the distance that should be allowed between plants of each type when planted in rows. The smallest number shows the distance that should be allowed between a plant and another plant of the same type in a single row, while the largest number shows the distance that should be allowed between rows.

The plant list 40 of FIG. 5 further contains a planting calendar 46 and calendar key 47. The planting calendar 46 may be filled or cleared using check box 48. The calendar key 47 contains 3 categories: sow indoors/undercover; sow outdoors/plant out seedlings; and harvest. The planting calendar 46 contains colored bars corresponding to the categories in calendar key 47. The colored bars indicate a time period during which the corresponding activity indicated in the key should be performed. For example, bar 48 indicates that the tomatoes of the garden plan of FIG. 4 should be sown indoors between the middle of March and the middle of May, bar 49 indicates that the tomatoes of the garden plan of FIG. 4 should be planted outdoors between the middle of May and the end of June and bar 50 indicates that the tomatoes of the garden plan of FIG. 4 should be harvested between the middle of July and the end of October.

The planting calendar 46 of FIG. 5 is calculated according to the date of the first and last frosts in the garden that corresponds to the garden plan of FIG. 4. The first and last frost dates may be entered by a user and the planting dates for the planting calendar 46 can be calculated according to the entered frost dates. The first and last frost dates can be determined in any convenient way, for example published data indicating likely frost dates can be used to determine the first and last frost dates entered by a user.

The planting calendar 46 can be used as a basis for the generation of reminders which can be provided to a user relating to tasks which should be carried out at a particular time. Such reminders can be provided in any convenient form. For example, where data representing the planting calendar is stored at a server, reminders can suitably be provided in the form of email messages.

As has been described above, different plans may be created for the same growing area in different years. A plan for a subsequent year may be based upon previous years plans. FIG. 6 shows a screen for creation of a new garden plan that is opened from the screen of FIG. 4 by selecting a new plan icon 51 from the system tools 11. A user can specify a name for the plan to be created in a text box 52a. By default, the name shown in the text box 52a may be based upon a name of an existing plan. A user can also select a year for the plan to be created by using a drop down list 52b. The user can specify either that a blank plan is to be created or alternatively that a new plan based upon an existing saved plan is to be created using selection icons 53. Creating a new plan based upon an existing saved plan links the new plan to the previous plan, and to any plan to which the previous plan is also linked. In this way data associated with linked plans may be imported into the newly created plan to aid the user as described in further detail below.

A user may further choose the existing plan on which the new plan is to be based using drop down list 54 and can choose which of the layout of the previous garden, the text and the plants are to be copied using selection icons 55. If a user chooses to base the new plan on an existing garden plan, data is imported from the previous plan to the new plan, as is described in further detail below.

If the user uses the selection icons 53 to indicate that a blank plan should be created, a size for the blank plan is specified using text boxes 53a, 53b, in units (i.e. metric or imperial) which are specified using radio buttons 53c.

Referring now to FIG. 7, a plan 70 for the year 2009 is shown as indicated by tab 71. Vegetable beds 72, 73 and 74 are automatically created in the new garden plan from data imported from the garden plan of FIG. 2 and are placed in identical locations to the representations of vegetable beds 15, 16, 17 of FIG. 2.

An eggplant (aubergine) plant icon 75 has been selected from the growing icons 12 and is shown in the representation of a vegetable bed 72. Shaded areas 76 appear on the plan as soon as the eggplant plant icon is selected. The shaded areas 76 indicate where plants in the same family as the selected eggplant plant 75 were placed on previous years' plans. Shaded areas 76 indicate that the eggplant plant should not be placed in these areas. The shaded areas 76 correspond to areas in which the tomato and potato plants were planted in the 2008 plan shown in FIG. 4, given that eggplant, tomato and potato plants are all members of the Solanaceae family.

The shaded areas 76 provide a clear visual indicator to aid the planning of a garden. Planting of plants that belong to the same family in the same area is not recommended in consecutive years due to the similar nutrient requirements of plants that belong to the same family. Crop rotation can improve soil fertility and structure and help manage diseases and insects that affect a specific plant family. Providing a visual indicator in this way helps gardeners manage their crop rotations.

Historical planting data is imported into a new plan from the plans of the previous five years. Selection of a plant in a given family causes a shaded area to appear for any area in which a plant in the same family was planted in a plan for any of the preceding five years that is linked to the current plan. The problems associated with planting plants from the same family in the same area are lessened by the time that passes between the planting of plants from the same family. Therefore, in order to represent this information, the strength of shading indicating areas in which planting should not occur is dependent upon how recently a plant in the same family has been planted in a particular area. That is, the shaded areas 76 of FIG. 7 are particularly strong given that they indicate areas in which plants from the Solanaceae family were planted in the immediately preceding year. If plants from the Solanaceae family had, in fact, been planted in those areas three years previously, weaker shading would be displayed. It will be appreciated that different colors could be used in the place of different strength of shading.

In the preceding description, it has been explained that historical data can be used to indicate areas in which a particular plant should not be planted. In alternative embodiments of the invention, historical data can be used to indicate areas in which a particular plant should be planted. Such areas can be indicated either based upon areas in which plants from the same family have not been planted in the preceding five years, or alternatively, based upon a particularly beneficial interaction between a particular plant and plants of a family planted in a particular area in the same year or preceding years. Planting plants in the same year that are believed to have a beneficial interaction is known as companion planting. Alternatively other factors could be used such as historical soil treatments, shade, moisture or soil pH levels.

The preceding description has described how an application can be implemented to allow plans of a growing area to be created. The application can be implemented in any convenient way. For example, the application can be implemented as standalone software which is run on a user's computer. Such standalone software can store data required by the application in a storage device provided by the user's computer, for example a hard disk drive. However, in one embodiment of the invention, the application is implemented using a client-server model.

Referring to FIG. 8, it can be seen that a client computer 77 communicates with a server computer 78 over the Internet 79. The server computer 78 provides web pages to the client computer 77 which are displayed by the client computer 77 in a web browser. Web pages provided by the server computer 78 to the client computer 77 include content created using Adobe® Flash® which can be displayed on the client computer 77 using a Flash-plugin installed as part of the web browser running on the client computer 77. The flash content included in the provided webpages is arranged to provide the functionality described above.

It can be seen from FIG. 8 that the server computer 78 has access to a database 80. The server computer 78 is arranged to read data from and write data to the database 80. The database 80 stores data indicating registered users of the application provided by the server computer 78, and also stores data indicating garden plans created by those users as is now described.

Referring now to FIG. 9, a plurality of database tables which make up the database 80 are shown, together with relationships between those database tables.

A users table 81 has fields for storing data about users of the planning application described above. A layouts table 82 stores user garden plan data for garden plans of the type described above. The layouts table 82 has a userID field through which the layouts table references records of the users table 81, and in this way each layout represented by a record of the layouts table 82 has an associated user. A single userID may be referenced by multiple layouts, thereby allowing a user to create a plurality of plans. Each record of the layouts table 82 represents a particular plan which can be displayed by the application in the manner described above.

The database further comprises a layoutData table 83, a textData table 84 and a planData table 85. The layoutData table 83 has a layoutID field through which records of the layoutData table 83 identify records of the layouts table 82, the textData table 83 has a textID field through which records of the textData table identify records of the layouts table 82. The planData table 84 has a planID field through which records of the planData table reference a record of the layouts table 82. Each layout in the layouts table 82 may be referenced by multiple records of the layoutData, textData and planData tables. In this way a particular plan is defined by a record of the layouts table 82 and one or more records of the layoutData table 83, the textData table 84 and the planData table 85, as described in further detail below.

The database further comprises a vegData table 86 which has a number of fields storing data on each of the possible plants that may be placed on a plan as described above. Plants in the vegData table 86 are referenced by a vegCode field in the planData table 85.

Referring to FIG. 10, a simplified example database is shown. The users table 81 is populated with three users, each user having respective entries in a username field, a countryCode field, a lastFrostDay field and a firstFrostDay field. The lastFrostDay fields and firstFrostDay fields are used to determine planting dates in a planting planner such as the planting planner shown in FIG. 5.

The layouts table 82 is populated with data representing six plans. Each record of the layouts table 82 has a userID field, a layoutName field, a layoutYear field and five historyID fields. The userID field references a user in the users table 81. The layoutName field provides a name for the layout, for example the front garden or back yard so a user can distinguish between multiple plans which have been created. The layoutYear field identifies the year for which the layout plan is to be implemented in the garden of the user. HistoryID fields identify previous layouts to which a particular layout is linked. For example the layout with layoutID 6 is linked to layouts with layoutIDs 5, 4 and 1. This data is used to determine which previous vegetable data should be looked up when displaying shaded warning areas such as areas 76 in FIG. 7.

The layoutData table 83 stores data defining drawing objects. Each entry of the layoutData table has a layoutID field which references a layout in the layouts table. In this way, each record of the layoutData table 83 is associated with a plan represented by a record of the layouts table 82.

Referring to the layoutData table 83, the records of the layoutData table 83 having recordIDs 1, 2 and 3 are all related to the record of the layouts table 82 having layoutID, 1, indicating that the plan represented by the record of the layouts table 82 having layoutID 1 comprises three drawing objects. The objectID field references the order of creation of each object within a layout and the objectType field indicates the type of drawing object such as a rectangle or circle. The color, width and filled fields store data indicating formatting properties of the object.

The textData table 84 stores data relating to text objects included within plans. The textID field references a layout in the layouts table. For example records in the textData table 84 having recordIDs of 1 and 2 both have textID 1 indicating that each of these entries of the textData table 84 is associated with the record of the layouts table 82 having a layoutID of 1. The color, size, italic, bold and underline fields store data indicating formatting properties of text and the textString field stores the text of the text object.

The planData table 85 relates to plant objects included in a garden plan. The planID field references a layout in the layouts table 82. For example records of the planData table 85 having recordIDs of 1, 2 and 3 all have a planID of 1 indicating that each of these records is associated with the layout having a layoutID of 1. The vegCode field references vegetable data in the VegData table 86.

The startX, startY, endX, endY, midX and midY fields of the layoutData table, textData table and PlanData table indicate coordinate values for an object represented by a particular record of the respective table. The action field of each of these tables indicates a create, alter or delete action. That is, where an object is created and subsequently deleted, it will have two entries in the relevant table, a first having an action of create, and a second having an action of delete. This allows “undo” functionality to be provided by simply processing records of the relevant table to determine when particular objects where created, altered and deleted.

The vegData table 86 stores a record for each of the vegetables that may be added to a plan. The vegCode field is a reference used by the planData table to identify data relating to plant objects in a plan. The vegName field indicates the name of the vegetable with the given reference. The countryCode field is used to determine the correct name to be used for a particular vegetable for a given user. For example if a user in the users table 81 has countryCode “us” the American name of a vegetable will be used and if the user has countryCode “uk” the UK name will be used. The family field indicates the family to which the particular vegetable belongs such as Brassica or Umbelliferae. The family field is used to determine the areas of a plan that have previously had vegetables in the same family placed in a previous years plans, in combination with the historyID fields of the layout table 81, using a simple lookup.

The spacing, in RowSpacing and rowSpacing, fields of the vegData table 86 store data indicating the correct spacing distances. The data contained in the spacing fields is used to calculate the number of plants which should be included in a row selected by a user on the plan, and to provide the visual indication of the optimal area required around a plant once placed on the plan. The daysBeforeFrost field indicates the number of days before or after the last frost data that a plant should be planted outdoors. This data is used in combination with the lastFrostDay data of the user table 81 to determine a planting plan such as the one shown in FIG. 5.

Referring back to FIG. 8, it can be seen that further fields are contained in the database tables. These further fields are used to store further information for the various aspects of the planning application.

Although various embodiments of the invention have been described in detail, it will be appreciated that this description is intended to be in all respects illustrative, not restrictive. In particular, it will be appreciated that various changes may be made to the described embodiments without departing from the spirit and scope of the invention.

1. A computer implemented method of displaying a plan of an area for growing plants, the method comprising:
displaying a graphical representation of said area;
receiving from a user selection of a plant to be included in said plan; and
displaying a graphical representation of said user selected plant wherein said graphical representation of said user selected plant indicates a growing area required for optimal growth of said plant.

2. A method according to claim 1, wherein said indicated growing area is determined based upon space required by the selected plant above and below soil in which the plant is to be planted.

3. A method according to claim 1, further comprising:
receiving from a user a selection of an area of said plan to be populated with said selected plant.

4. A method according to claim 1 further comprising calculating a quantity of said selected plant based upon said growing area and said user selection of an area.

5. A method according to claim 4, further comprising:
displaying data indicating said calculated quantity.

6. A method according to claim 5, wherein a single plant is represented by an icon, and said quantity is indicated by the number of displayed icons.

7. A method according to claim 1, wherein said graphical representation of said user selected plant further comprises an indication of a classification of said selected plant.

8. A method according to claim 7, wherein said classification is a classification based upon a plant family of the user selected plant.

9. A method according to claim 8, wherein said plant family is selected from the group consisting of Solanaceae, Brassicaceae, Alliaceae, Chenopodiaceae, Umbelliferae, Leguminosae, Cucurbitaceae and Miscellaneous.

10. A method according to claim 1, further comprising, for each of a plurality of plants:
storing first data indicating a growing area required for optimal growth of said plant when planted individually; and
storing second data indicating a growing area required for optimal growth of said plant when planted in rows.

11. A computer readable medium carrying computer readable instructions arranged to cause a computer to:
display a graphical representation of said area;
receive from a user selection of a plant to be included in said plan; and
display a graphical representation of said user selected plant wherein said graphical representation of said user selected plant indicates a growing area required for optimal growth of said plant.

12. A server computer arranged to allow a user to display a plan of an area for growing plants, the computer comprising means for providing to a client computer computer readable instructions arranged to:
display a graphical representation of said area;
receive from a user selection of a plant to be included in said plan; and
display a graphical representation of said user selected plant wherein said graphical representation of said user selected plant indicates a growing area required for optimal growth of said plant.

13. A computer implemented method of displaying a plan of an area for growing plants, the method comprising:
displaying a graphical representation of said area;
receiving from a user selection of a plant to be included in said plan;
displaying a graphical representation of said user selected plant wherein said graphical representation of said user selection indicates a plant family to which the selected plant belongs.

14. A method according to claim 8, wherein said plant family is selected from the group consisting of Solanaceae, Brassicaceae, Alliaceae, Chenopodiaceae, Umbelliferae, Leguminosae, Cucurbitaceae and Miscellaneous.

15. A method according to claim 13, wherein said graphical representation of said user selection comprises a color, and said color indicates a plant family to which the selected plant belongs.

16. A computer readable medium carrying computer readable instructions arranged to cause a computer to:
display a graphical representation of said area;
receive from a user selection of a plant to be included in said plan; and
display a graphical representation of said user selected plant wherein said graphical representation of said user selection indicates a plant family to which the selected plant belongs.

17. A server computer arranged to allow a user to display a plan of an area for growing plants, the computer comprising means for providing to a client computer computer readable instructions arranged to:
display a graphical representation of said area;
receive from a user selection of a plant to be included in said plan; and
display a graphical representation of said user selected plant wherein said graphical representation of said user selection indicates a plant family to which the selected plant belongs.

18. A computer implemented method of displaying a plan of an area for growing plants, the method comprising:
displaying a graphical representation of said area;
receiving from a user selection of a plant to be included in said plan;
indicating parts of said area that are suitable for planting said selected plant based upon said plant selection and historical data.

19. A method according to claim 18 wherein said historical data is historical planting data for said area for growing plants.

20. A method according to claim 19 wherein said historical planting data is automatically generated from at least one previous plan for said area for growing plants.

21. A method according to claim 19 wherein said historical data is stored in a database.

22. A method according to claim 18, wherein indicating parts of said area that are suitable for planting said selected plant comprises:
displaying graphical data indicating areas which are not suitable for planting said selected plant.

23. A method according to claim 18, wherein indicating parts of said area that are suitable for planting said selected plant comprises:
displaying graphical data indicating areas which are suitable for planting said selected plant.

24. A method according to claim 22, wherein said graphical data indicates a degree of suitability of a particular area for planting said selected plant.

25. A computer readable medium carrying computer readable instructions arranged to cause a computer to:
display a graphical representation of said area;
receive from a user selection of a plant to be included in said plan; and
indicate parts of said area that are suitable for planting said selected plant based upon said plant selection and historical data.

26. A server computer arranged to allow a user to display a plan of an area for growing plants, the computer comprising means for providing to a client computer computer readable instructions arranged to:
display a graphical representation of said area;
receive from a user selection of a plant to be included in said plan; and
indicate parts of said area that are suitable for planting said selected plant based upon said plant selection and historical data.

27. A computer implemented method of planning an area for growing plants comprising:
receiving data indicating a plan for an area for growing plants including data indicating plant selections; and
automatically generating a planting plan indicating when said selected plants should be planted based upon said plan and stored data indicating characteristics of the selected plants.

28. A method according to claim 27, wherein said planting plan is generated further based upon data indicating at least one climatic condition.

29. A method according to claim 28, wherein said at least one climatic condition is based upon a frost date.

30. A method according to claim 27, further comprising:
generating at least one reminder message based upon said planting plan indicating when said selected plants should be planted;
providing said at least one reminder message to a user.

31. A computer readable medium carrying computer readable instructions arranged to cause a computer to:
receive data indicating a plan for an area for growing plants including data indicating plant selections; and
automatically generate a planting plan indicating when said selected plants should be planted based upon said plan and stored data indicating characteristics of the selected plants.

32. A server computer arranged to allow a user to display a plan of an area for growing plants, the computer comprising means for providing to a client computer computer readable instructions arranged to:
receive data indicating a plan for an area for growing plants including data indicating plant selections; and
automatically generate a planting plan indicating when said selected plants should be planted based upon said plan and stored data indicating characteristics of the selected plants.
